(19) United States
(12) Patent Application Publication
(10) Pub. No.: US 2002/0001636 A1
(43) Pub. Date: Jan. 3, 2002

(54) Surface texture applicator

(76) Inventor: Greg Holloway, Orange Park, FL (US)

Correspondence Address: Law Office of Thomas C. Saitta, P.A., Suite 203, 6821 Southoint Dr. North, Jacksonville, FL, 32216, US

(21) Appl. No.: 09/887,981

(22) Filed: Jun. 25, 2001

Related U.S. Application Data
(60) Provisional application No. 60/215,274, filed on Jun. 30, 2000.

(51) Int. Cl. B29C 59/00

(52) U.S. Cl. 425/385; 425/458

(57) ABSTRACT

A hand-held applicator tool for applying uncured texture material to a base surface as an intermediate step in creating a knockdown textured surface, the tool having a handle, a backing member and sponge-like compressible member, where the face surface of the compressible member is provided with a plurality of irregularly distributed, sized and shaped voids which receive varying amounts of texture material for transfer of the texture material onto the base surface in an irregular pattern.

This application claims the benefit of U.S. Provisional Application Ser. No. 60/215,274, filed Jun. 30, 2000.

### BACKGROUND OF THE INVENTION

The invention relates generally to the field of devices used to create non-smooth surface finishes on walls, ceilings, pool decks and like surfaces, and more particularly to such devices which create an irregular texture pattern on the surface, often called a knockdown finish. Even more particularly, the invention relates to hand-held applicator devices used to deposit irregular, uneven bumps, globules or protrusions of a plaster-type material onto a generally planar base surface, the bumps then being partially smoothed to create irregularly shaped patches of material having a generally flat surface but which are disposed outwardly from the base surface and separated by irregular gaps or channels.

Textured or non-smooth surfaces, whether used for decorative purposes, such as creating visually perceptible patterns of regular or irregular shape, or for functional purposes, such as muffling sound or increasing traction, are well known in the wall, ceiling and floor construction arts. Plaster or plaster-like texture materials which can be applied to a base surface in an uncured or wet, formable state are utilized to create the three-dimensional surface texture, such as for example Gyproc Wall and Texture brand, manufactured by G-P Gypsom Corp. or Acusti Tex brand manufactured by Tool World, Inc. Such textured surfaces are known as knockdown surfaces in the trade, since a typical method of production involves first creating a generally planar or smooth base surface, next applying individual bumps, globules or masses of the texture material in irregular patterns onto the base surface, then utilizing a trowel or bladed tool to partially flatten or “knock down” these irregular masses, which are allowed to cure or harden such that the wall, ceiling or floor now comprises a discontinuous outer surface of slightly raised plateaus having a generally planar face, where the gaps in the outer surface between plateaus may expose the base surface.

To create textured surfaces on large surface area walls, ceilings or floors, the irregular masses of texture material are typically applied using a pressurized spray applicator or a powered rotating applicator which randomly sling or deposit the masses of texture material onto the base surface. Such devices are relatively cumbersome and expensive to purchase, and producing an acceptable knockdown surface requires certain levels of skill and experience. Furthermore, such devices are not useful in creating textured surfaces of relatively small surface area, or in making repairs to existing textured surfaces, where matching of the repair surface to the remaining original surface is desired.

To address the problems associated with small surface area applications, as well as to provide a relatively simple and inexpensive tool for creating textured surfaces which can be purchased by a homeowner, several hand held devices are known. For example, in U.S. Pat. No. 4,007,879, issued Feb. 15, 1977, to Jensen, an applicator device is disclosed which comprises a plural number of short, flexible, hollow tubes joined in communicating manner to a hollow handle. The flowable texture material is deposited into the handle and pumped into the flexible hollow tubes. The flexible tubes are then snapped or whipped in the direction of the base surface, whereby the texture material is ejected from the tubes in droplet form onto the base surface in a random pattern. The masses of texture material are then smoothed in normal fashion to create the final textured surface. A drawback to this device is that the user cannot control the direction or amount of texture material ejected from the flexible tubes, and the ejected masses are typically of relatively small volume. This results in the creation of a speckled texture pattern, the device not being useful for creating large irregular masses which cover significant surface area on the base surface. U.S. Pat. Ser. No. 5,401,231, issued Mar. 28, 1995, to Hebert shows a roller device which incorporates a large number of leather disks mounted onto the roller in close proximity whereby the edges of each disk are folded outwardly from the roller surface due to contact with adjacent disks. The texture material may be picked up by rolling the roller in a tray containing the texture material, or the texture material may be pumped though the interior of the roller where it exits through apertures disposed between the disks. This device is likewise not useful in creating texture surfaces with large irregular masses covering significant surface area of the base surface, as the pattern formed will be somewhat repetitious due to the roller application method, and clean-up and manufacture of the device will be very difficult. U.S. Pat. No. 5,771,525, issued Jun. 30, 1998, to Fulcher et al. discloses another type of applicator device for creating textured surfaces. This device has a plural number of short, flexible fingers or rods made of a foam material, all bundled onto the end of a handle. The fingers are dipped into the texture material and the material is then dabbed onto the base surface. This device will only apply small amounts of texture material in a small surface area during each contact with the base surface, and the masses of texture material applied will all be relatively equal in volume.

It is a purpose of this invention to provide a hand-held or manual applicator device for applying texture material to a base surface for subsequent leveling to create a knockdown textured surface, where the appearance of the finished textured surface is equivalent to that of a surface produced by pressurized spray applicators or the like spattering equipment. It is a further object to provide such a device which may be utilized to create a textured surface of relatively small surface area. It is a further object to provide such a device which comprises a sponge-like compressible member having a plural number of irregularly spaced, sized and shaped voids adapted to receive uncured texture material for transfer onto a base surface. It is a further object to provide such a device which is easy to use and clean, which provides a high level of control in application, and which is relatively inexpensive to manufacture. These objects, and other objects not expressly set forth, will be accomplished as disclosed below.

### SUMMARY OF THE INVENTION

The invention is in general a hand-held tool or applicator device for applying uncured or wet, formable, texture material, such as plaster, stucco or the like, to a base surface such as a wall, ceiling or floor in a random, irregular pattern comprising individual masses, globules or bumps of texture material extending three-dimensionally outward from the base surface, whereby such masses of texture material can then be partially smoothed to present a generally planar outer surface of discontinuous, raised plateaus disposed a short distance from the base surface. The base surface may or may not be exposed in the irregular gaps or channels between the plateaus.

The texture applicator device comprises a handle and a relatively rigid, relatively non-compressible backing member which retains a generally coextensive, compressible, sponge-like member composed of an expanded foam polymer material, where the exposed surface or face of the compressible member is provided with a plural number of depressions or voids which extend preferably between approximately one quarter to one half inch in depth. The voids are irregularly disposed or arranged on the face of the compressible member, and are of irregular shape, preferably with curved rather than angular surfaces, and some of the voids overlap or connect to each other to define extended irregular shapes.

The device is utilized by applying uncured texture material to the exposed face surface of the compressible member using a trowel or similar device to fill the voids, or by pressing the face surface of the compressible member into a tray or receptacle containing uncured or wet texture material such that the texture material fills and is retained by the voids in the compressible member. The face surface is then pressed onto or against the base surface where the textured surface is to be created, which results in a transfer of the uncured texture material onto the base surface. Because different amounts of texture material are retained by the voids of the compressible member at different locations, different amounts of texture material will be transferred to the base surface at different locations. This results in masses of deposited texture material which are irregularly shaped and irregularly dispersed, and which vary in the amount of texture material contained within each mass. When the masses are subsequently partially flattened with a trowel or similar tool to create the plateau texture surface, the plateaus will vary in shape and size, thus producing the desired irregular texture pattern.

### BRIEF DESCRIPTION OF THE DRAWINGS

FIG. 1 is a perspective view of a preferred embodiment of the invention.

FIG. 2 is a perspective view of an alternative embodiment of the invention.

FIG. 3 is a view of the face surface and voids of the compressible member.

FIG. 4 is a view of a texture pattern created by using the invention, with the texture pattern shown in finished form after having been smoothed.

### DETAILED DESCRIPTION OF THE INVENTION

With reference to the drawings, the invention will now be described in detail with regard for the best mode and the preferred embodiments. In a most general sense, the invention is a hand-held or manual applicator tool for applying texture material, such as plaster or other plaster-like compositions which in the wet or uncured state will adhere to base surfaces, such as a wall, ceiling or floor, and which can be shaped, molded or smoothed as desired to create a shape or surface configuration, and which harden upon drying or curing. The invention is used during an intermediary step in creating what is known in the art as a knockdown surface, where irregularly spaced, irregularly shaped plateaus are formed which extend a small distance outward from the base surface for decorative or functional purposes.

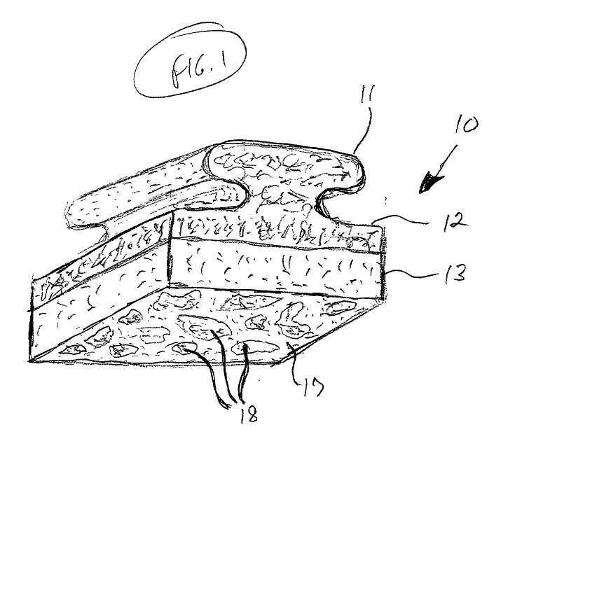

As shown in FIG. 1, the invention is a hand-held applicator tool device 10 comprising in combination gripping means such as a handle member 11, a relatively rigid backing member 12 to which the handle member 11 is joined, and a sponge-like compressible member 13 which is attached to the backing member 12, typically by adhesive or other bonding means. The handle member 11 may take many shapes and configurations, but should be designed for easy gripping and control, and as shown consists of relatively rigid expanded polymer foam material formed coextensively with the backing member 12. In an alternative embodiment, the outer edges of the backing member 12 itself may comprise the handle member 11, such that the perimeter serves as the gripping means to hold the tool 10. The rigidity of the handle member 11 and backing member 12 is greater than that of the compressible member 13, and the compressibility of the backing member 12 is less than that of the compressible member 12, which may be accomplished by utilizing different polymer foams for the handle/backing member combination 11/12 and the compressible member 13, by forming the handle/backing member combination 11/12 at a higher density than that of the compressible member 13, or by providing structural members internally or externally to the handle/backing member combination 11/12. The backing member 12 must provide enough structural rigidity to the compressible member 13 such that sufficient pressure can be applied to compress the compressible member 13 in order to transfer the uncured texture material onto a base surface.

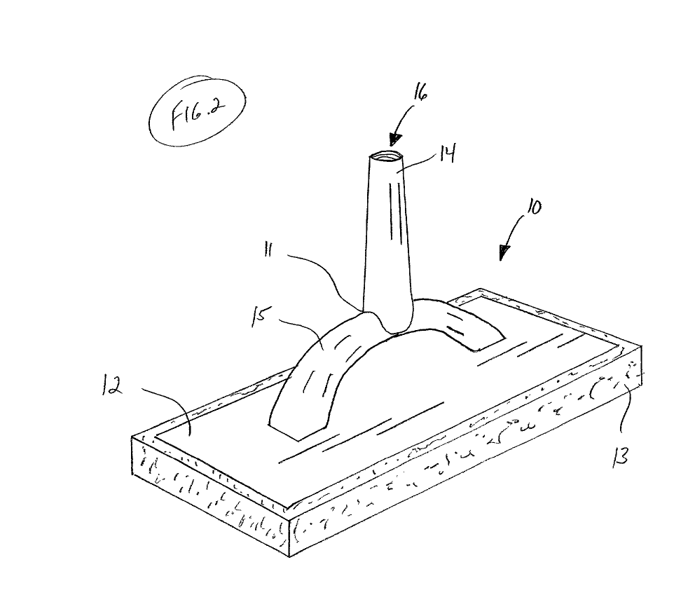

An alternative embodiment for the invention is shown in FIG. 2, where the hand-held applicator tool device 10 comprises in combination a handle member 11 to be gripped by the user, a relatively rigid backing member 12 to which the handle member 11 is attached, and a sponge-like compressible member 13 which is attached to the backing member 12, typically with mechanical fastener means. The handle member 11 may take many shapes and configurations, and as shown consists of an extended gripping shaft member 14, which is preferably cylindrical or conical in shape, connected to the generally planar backing member 12 by a bridging connector member 15, where the shaft member 14 is disposed generally perpendicularly to the exposed surface of the backing member 12. Means 16 to connect an extension handle to the handle member 11 may be provided, such as an externally threaded end or an internal socket, as shown, threaded or non-threaded. The handle member 11 may be formed of wood, plastic, metal or any other suitable material.

The backing member 12 in this embodiment is preferably a generally thin, planar member having a relatively small depth dimension relative to its length and width dimensions, and as shown is preferably formed in a rectangular shape, although other shapes are possible without departing from the spirit of the invention. The backing member 12 must be relatively rigid and stiff in order to provide sufficient rigidity to the compressible member 13, and therefore is preferably formed of a sheet metal or rigid plastic.

The compressible member 13 for either embodiment is formed or affixed to the backing member 12 on the side opposite the handle member 11 using suitable manufacturing techniques, adhesives or other attachment means. The sponge-like compressible member 13 is formed of a polymer foam material, preferably having relatively fine texture with tiny air pockets between the polymer material, which retains an expanded configuration in the passive condition but which may be flattened against the backing member 12 when force is applied. The overall configuration of the compressible member 13 generally corresponds to the configuration of the backing member 12. The depth dimension of the compressible member is less than that width and length dimensions, and the depth of the compressible member 13 is preferably greater than the depth dimension of the backing member 12.

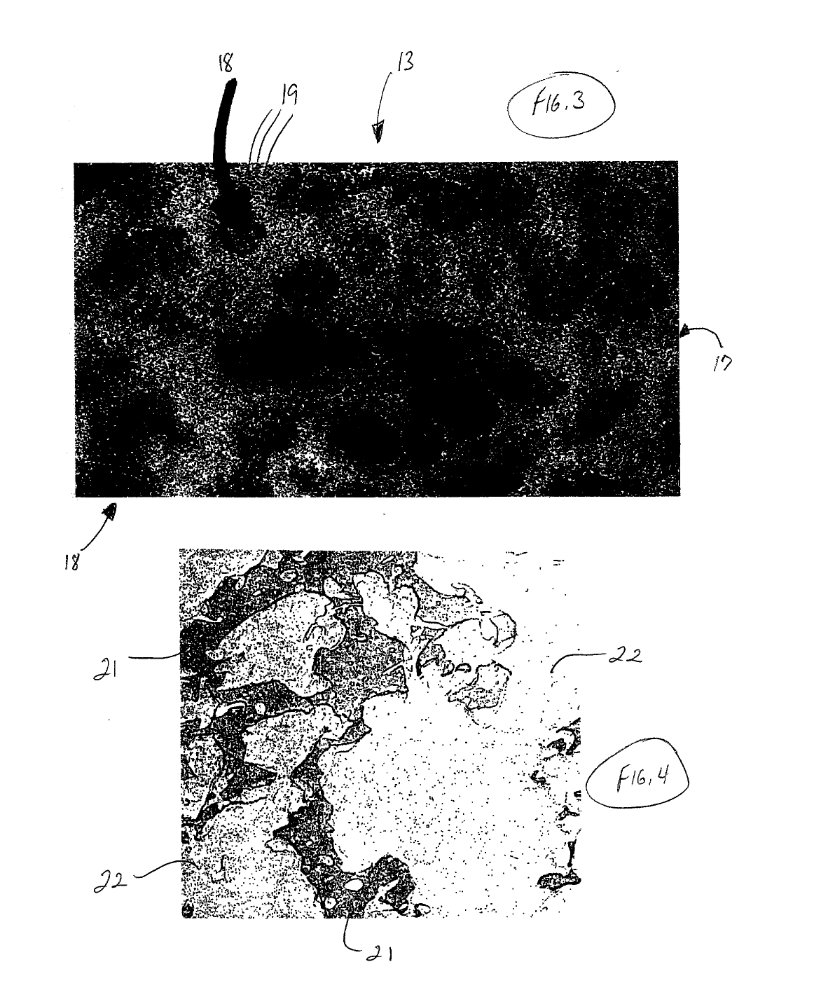

As shown in FIG. 3, the compressible member 13 presents a generally planar, exposed applicator face surface 17 having a relatively large number of voids, pockets or depressions 18 disposed thereon. The voids 18 are randomly distributed on face surface 17, and have varying depths, sizes and configurations. The voids 18 are of significantly greater size than the small air pockets 19 which define and create the foam material itself. Preferably, voids 18 having depths and widths from approximately one quarter to one half inch are suitable, but voids 18 of greater or smaller depth or width may be utilized. The voids 18 preferably have curved rather angular surfaces and perimeters, and many adjacent voids 18 will preferably overlap on the face surface 17 of the compressible member 13 to form larger, extended irregular shapes. The voids 18 may be formed in any suitable manner, such as by mechanically cutting or shearing to remove material from the body of compressible member 13, by applying a liquid solvent to dissolve portions of the material, or the voids 18 may be molded in during the formation process of the compressible member 13. One highly efficient method for forming the voids 18 in the compressible member 13 is to press the face surface 17 through a thin plate containing randomly sized, shaped and distributed apertures, such that small portions of the compressible member 13 protrude through the apertured plate. These protruding portions are then sheared off to create the voids 18.

To utilize the applicator tool device 10 to produce a finished surface as shown in FIG. 4, the user grasps the handle member 11 and applies uncured texture material to the face surface 17 of the compressible member 13, typically by using a hand trowel to scrape texture material across the face surface 17 such that texture material fills the voids 18. Alternatively, the face surface 17 of the compressible member 13 may be pressed directly into a tray containing uncured textured material. Larger voids 18 will retain more texture material than smaller voids 18. With the texture material adhering temporarily to the compressible member 13, the face surface 17 is then pressed against a base surface 21, such as a properly prepared wall, ceiling or floor, and the tool 10 is withdrawn. The contact with the base surface 21 and the compression of the backing member 12 against the compressible member 13 causes the texture material to transfer onto the base surface 21, such that three-dimensional, irregular masses or globules of texture material corresponding to the voids 18 in the face surface 17 are deposited onto the base surface 21. These masses of texture material extend outward from the base surface 21 in an irregular pattern with curved or uneven surfaces of varying height and are separated by channels or gaps where no or very little texture material is deposited onto the base surface 21. Once a large region of the base surface 21 has been covered with texture material by successive applications of texture material from the tool 10, the tool 10 being rotated and translated each time so that the overall pattern remains random, the texture material masses are flattened by a trowel, blade or other known knockdown finishing implement to create plateaus 22 with generally flat outer surfaces separated by channels or gaps and which extend a short distance outward from the base surface 21. In this manner knockdown texture surface finishes, whether original or repair, can be easily and simply created.

It is understood that certain equivalents and substitutions may be obvious to those skilled in the art, and the true scope and definition of the invention therefore is to be as set forth in the following claims.

I claim:

1. A hand-held tool for applying masses of uncured texture material of differing size and shape to a base surface in an irregular pattern, said tool comprising:
a backing member; and
a compressible member joined to said backing member, wherein said backing member is more rigid than said compressible member, and wherein said compressible member is formed of a polymer foam material and comprises a face surface upon which are disposed a plural number of voids adapted to receive uncured texture material.

2. The tool of claim 1, wherein said backing member is formed of a polymer foam material.

3. The tool of claim 1, wherein said backing member is a thin, planar member.

4. The tool of claim 1, wherein said voids are disposed in an irregular pattern upon said face surface.

5. The tool of claim 1, wherein said voids differ in size, depth and shape.

6. The tool of claim 1, further comprising a handle member joined to said backing member.

7. The tool of claim 1, wherein said compressible member comprises a plural number of air pockets which defines said polymer foam material, and further wherein said voids are of greater size than said air pockets.

8. The tool of claim 1, wherein said voids have depths and widths ranging from approximately one quarter to one half inch.

9. The tool of claim 1, wherein said voids have curved surfaces and perimeters.

10. The tool of claim 1, wherein said backing member is denser and less compressible than said compressible member.

11. A hand-held tool for applying masses of uncured texture material of differing size and shape to a base surface in an irregular pattern, said tool comprising:
gripping means for holding said tool;
a backing member; and
a compressible member joined to said backing member, wherein said backing member is more rigid than said compressible member, and wherein said compressible member is formed of a polymer foam material and comprises a relatively planar face surface upon which are disposed a plural number of voids adapted to receive uncured texture material, said voids being of differing size and shape such that masses of uncured texture material of differing size and shape are retained within said voids for subsequent transfer to a base surface in an irregular pattern.

12. The tool of claim 11, wherein said gripping means comprises said backing member.

13. The tool of claim 11, wherein said gripping means comprises a handle member joined to said backing member.

14. The tool of claim 11, wherein said backing member is formed of a polymer foam material.

15. The tool of claim 11, wherein said backing member is a thin, planar member.

16. The tool of claim 11, wherein said voids are disposed in an irregular pattern upon said face surface.

17. The tool of claim 11, wherein said compressible member comprises a plural number of air pockets which defines said polymer foam material, and further wherein said voids are of greater size than said air pockets.

18. The tool of claim 11, wherein said voids have depths and widths ranging from approximately one quarter to one half inch.

19. The tool of claim 1, wherein said voids have curved surfaces and perimeters.

20. A hand-held tool for applying masses of uncured texture material of differing size and shape to a base surface in an irregular pattern, said tool comprising:
gripping means for holding said tool, said gripping comprising a handle member;
a backing member; and
a compressible member joined to said backing member, wherein said backing member is more rigid and less compressible than said compressible member, and wherein said compressible member is formed of a polymer foam material defined by a plural number of air pockets and comprises a relatively planar face surface upon which are disposed in an irregular pattern a plural number of voids of greater size than said air pockets and adapted to receive uncured texture material, said voids being of differing size and shape such that masses of uncured texture material of differing size and shape are retained within said voids for subsequent transfer to a base surface in an irregular pattern.
